(19) United States
(12) Patent Application Publication
(10) Pub. No.: US 2023/0202373 A1
(43) Pub. Date: Jun. 29, 2023

(54) POWER DOOR JAMB RAMP DOOR

(71) Applicant: Lippert Components, Inc., Elkhart, IN (US)

(72) Inventors: Kevin Stuart Walker, Milford, IN (US); Richard John Grothause, Angola, IN (US)

(21) Appl. No.: 18/089,002

(22) Filed: Dec. 27, 2022

Related U.S. Application Data
(60) Provisional application No. 63/293,676, filed on Dec. 24, 2021.

(51) Int. Cl. B60P 1/43; E05F 1/08

(52) U.S. Cl. CPC B60P 1/43; E05F 1/08; E05Y 2201/654; E05Y 2900/50

(57) ABSTRACT

A door operating mechanism displaces a door between a closed position and a deck position relative to a structure including a frame with a side door jamb and a head door jamb. The door operating mechanism includes a motor, and an actuator connected to the motor and disposed within the side door jamb. A cable is connected at one end to the actuator and at an opposite end to the door via a pulley assembly. A wire harness system electrically connects the motor to a plug connector. A control panel is mounted adjacent the door and is coupled with the motor via the wire harness system.

### CROSS-REFERENCES TO RELATED APPLICATIONS

This application claims the benefit of U.S. Provisional Patent Application No. 63/293,676, filed Dec. 24, 2021, the entire content of which is herein incorporated by reference.

### STATEMENT REGARDING FEDERALLY SPONSORED RESEARCH OR DEVELOPMENT

(NOT APPLICABLE)

### BACKGROUND

The invention relates to a lift assist for a door or a ramp door of a vehicular structure and, more particularly, to a powered ramp door assembly that is fully contained within the door jamb and can be easily and quickly connected to the vehicle power after installation.

It is known to provide a ramp door for a vehicular structure, for example, a recreational vehicle (RV) or trailer, where the ramp door is pivotable among a closed position, a deck position, and a ramp position. In the deck position, the door can be supported by cables and/or alternative supports to provide an extended outdoor use area adjacent a recreational vehicle or trailer. In a ramp position, the door may be lowered to the ground to permit loading and unloading of equipment from the RV or trailer.

An exemplary ramp door operating mechanism is described in U.S. Pat. No. 10,800,311, the contents of which are hereby incorporated by reference. In the described operating mechanism, a spring-mounted cable is driven by a motorized sprocket to open and close the door. The spring is configured to support a portion of the weight of the door while opening the door and to assist in closing the door.

### SUMMARY

In the powered ramp door assembly of the described embodiments, the controls are consolidated and self-contained at the side of the jamb, in contrast with existing assemblies that utilize controls installed as a touchpad. The door jamb can be pre-wired with wire harnesses for powering the door prior to installation, and the original equipment manufacturer (OEM) will be provided with a short “pig-tail” of wires to connect the jamb to vehicle power in a plug-n-play manner.

The wiring harness system may be completely integrated within the jamb. The jamb may also include a streamlined and fully-integrated control panel at the lower end of one side of the jamb including all operational features for the system.

The door actuation mechanism includes a motorized cylinder that is linearly displaceable to extend and retract a cable to thereby open or close the ramp door, respectively.

In an exemplary embodiment, a door operating mechanism serves to displace a door between a closed position and a deck position relative to a structure including a frame with a side door jamb and a head door jamb. The door operating mechanism includes a motor and an actuator connected to the motor and disposed within the side door jamb. A cable is connected at one end to the actuator and at an opposite end to the door via a pulley assembly. A wire harness system electrically connects the motor to a plug or plug-n-play connector. A control panel mounted adjacent the door is coupled with the motor via the wire harness system.

The mechanism may further include a compression spring interposed between the cylinder rod and the cable. The mechanism may further include a fixed tether connected between at least one of the side door jamb and the head door jamb and the door. The mechanism may further include one of an electric cinch latch and a manual compression latch for securing the door in a closed position. The mechanism may further include a gas shock secured to the side door jamb and positioned to engage the door in a closed position, where the gas shock is biased to displace the door toward an open position. The mechanism may further include a limit switch positioned in or adjacent one of the side door jamb and the head door jamb that disconnects power to the motor when the door is displaced to a closed position.

The control panel may include a key switch to activate the door operating mechanism and a rocker switch to extend and retract the cylinder rod. The key switch and the rocker switch may be connected to the motor via the wire harness system. The control panel may further include a warning indicator light and a mute button for silencing a warning buzzer. The control panel may include an SAE plug for battery backup connection.

The actuator may be a cylinder including an extendable and retractable cylinder rod. The wire harness system may be positioned within the door jamb. The control panel may be mounted on the side door jamb.

In another exemplary embodiment, a door operating mechanism includes first and second motors positioned within the frame, and first and second actuators respectively connected to each of the first and second motors and disposed within the side door jambs. First and second cables are each respectively connected at one end to the actuators and at an opposite end to the door via respective pulley assemblies. A wire harness system electrically connects the first and second motors to a plug or plug-n-play connector. A control panel is mounted adjacent the door and is coupled with the first and second motors via the wire harness system.

### BRIEF DESCRIPTION OF THE DRAWINGS

These and other aspects and advantages will be described in detail with reference to the accompanying drawings, in which:

FIG. 1 shows a ramp door pivotably connected to a structure such as a recreational vehicle or trailer in a deck position;

FIG. 2 is a perspective view of the frame including side door jambs and a head jamb;

FIG. 3 is an exploded view of the door operating mechanism;

FIG. 4 is a close-up view of the pulley assembly;

FIG. 5 is a circuit diagram of an exemplary electrical circuit;

FIG. 6 is a close-up view of the control panel mounted on the side door jamb; and

FIG. 7 shows the ramp door with an exemplary electric cinch latch.

### DETAILED DESCRIPTION

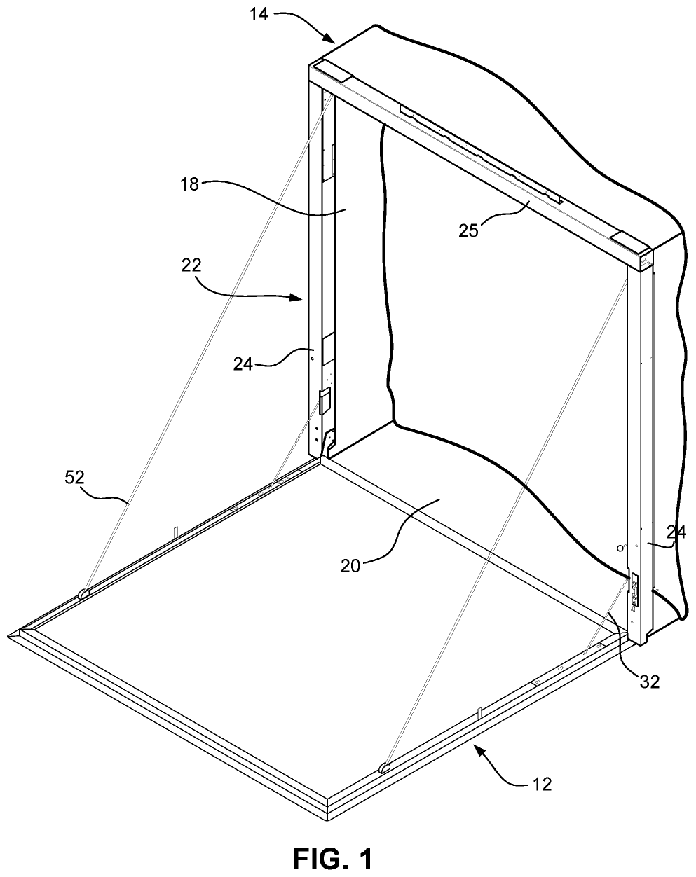

FIG. 1 shows a ramp door 12 pivotably connected to or otherwise pivotably associated with a structure 14. In some embodiments, the structure may be a vehicular structure, for example, an RV or trailer. The structure 14 includes an opening 18 and a floor 20.

The door is pivotably connected to or associated with the structure 14 so that the door 12 may be pivoted between a first or closed position in which the door covers or occupies the opening 18, a second or deck position in which the door is supported substantially parallel to the floor 20, and a third or ramp position further pivoted to the ground. When in the ramp position, the door 12 may provide contiguous access between the floor 20 and the ground upon which the structure 14 may be situated.

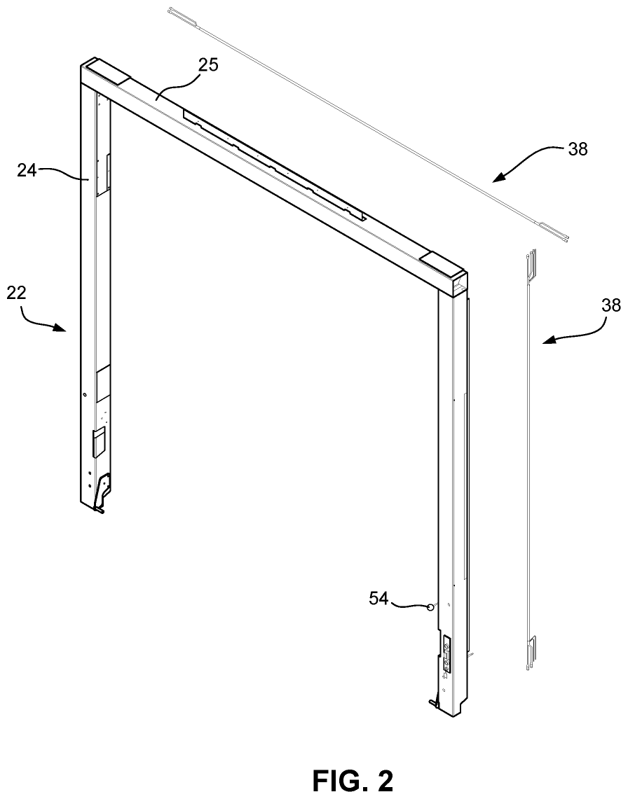

The structure 14 includes a frame 22 defined by a pair of side door jambs 24 and a head door jamb 25. See FIG. 2. In some embodiments, the side door jambs 24 and the head door jamb 25 are comprised of hollow or tube jambs. The frame 22 may be provided with removable access panels secured by screws. The panels would be selectively positioned to facilitate service to the system without having to completely dismantle or uninstall the mechanism.

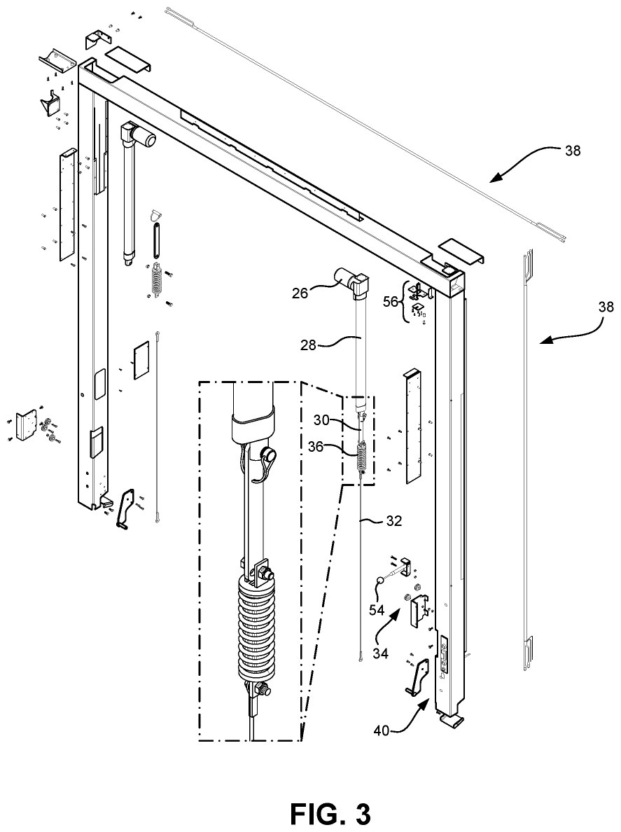

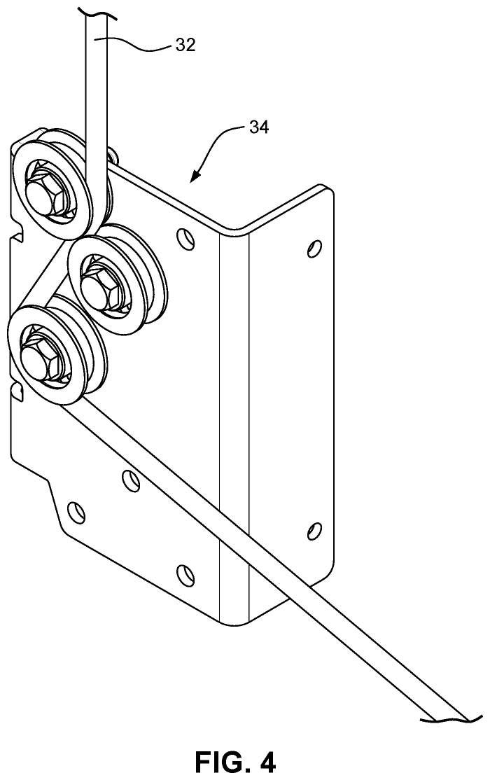

With reference to FIG. 3, the door operating mechanism includes a motor 26 that drives an actuator connected to the motor 26. In the embodiment shown, the actuator is a cylinder 28. The cylinder 28 includes an extendable and retractable cylinder rod 30. A cable 32 is connected at one end to the cylinder rod 30 and at an opposite end to the door 12 via a pulley assembly 34. In other embodiments, the actuator may be any other suitable mechanism for extending and retracting a cable or flexible member connected with the door. A close-up view of an exemplary pulley assembly 34 is shown in FIG. 4. In some embodiments, a compression spring 36 is interposed between the cylinder rod 30 and the cable 32. The spring 36 provides a biasing force to accommodate over-travel of the cylinder rod 30 and acts as a shock buffer when the door 12 is in the deck position or not fully deployed to the ground. In some embodiments, an actuation system including the motor 26, cylinder 28, cylinder rod 30 and cable 32 is provided on each side of the frame 22. The motors 26 are connected via a suitable wiring harness as part of the wire harness system 38 described in more detail below.

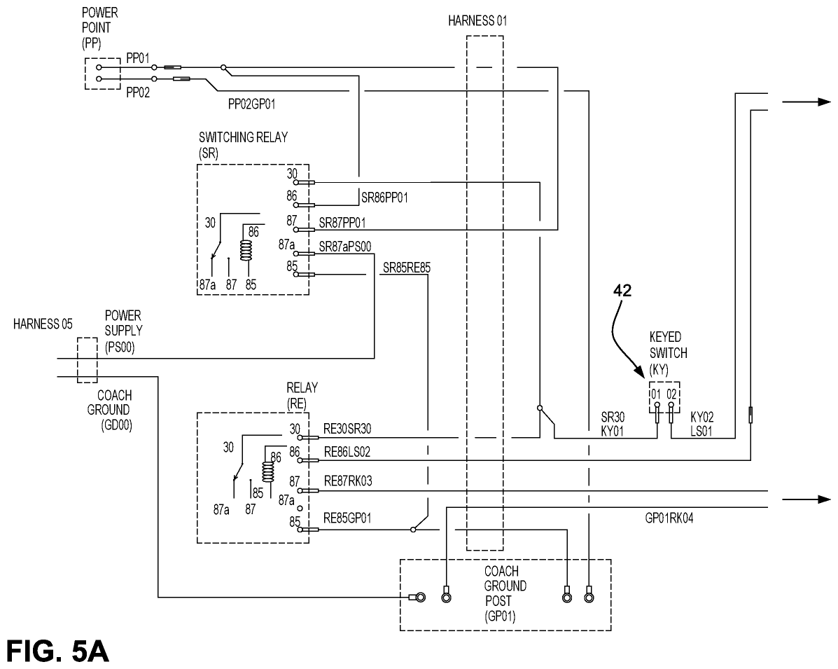

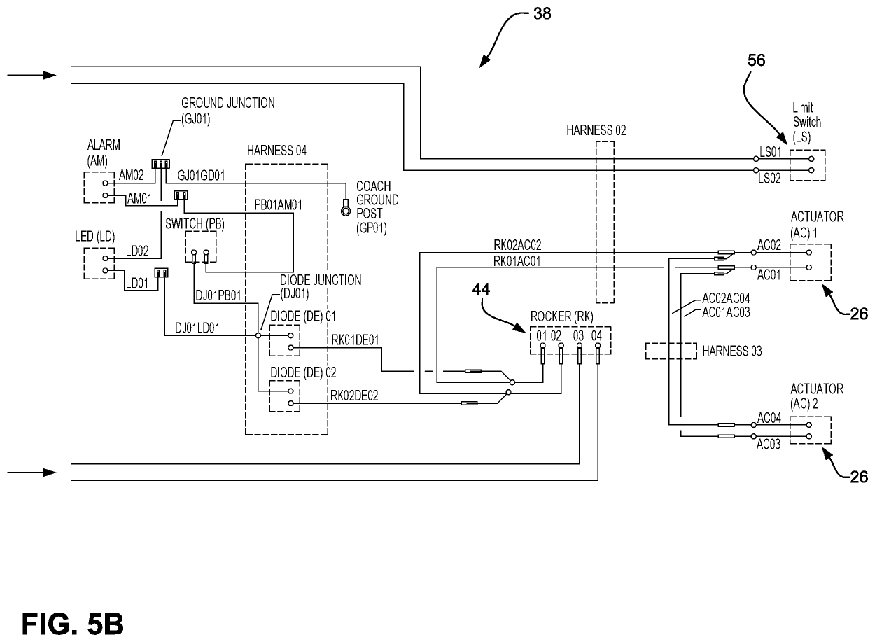

The wire harness system 38 may be integrated within the frame 22 and enables the system to be quickly and easily connected to vehicle power after installation. The frame 22 is pre-wired with the wire harness system for powering the door prior to installation, and the OEM is provided with a short “pig-tail” of wires to connect the system to vehicle power via a plug connector or plug-n-play connector. An exemplary electrical schematic with multiple wire harnesses in the wire harness system is shown in FIG. 5.

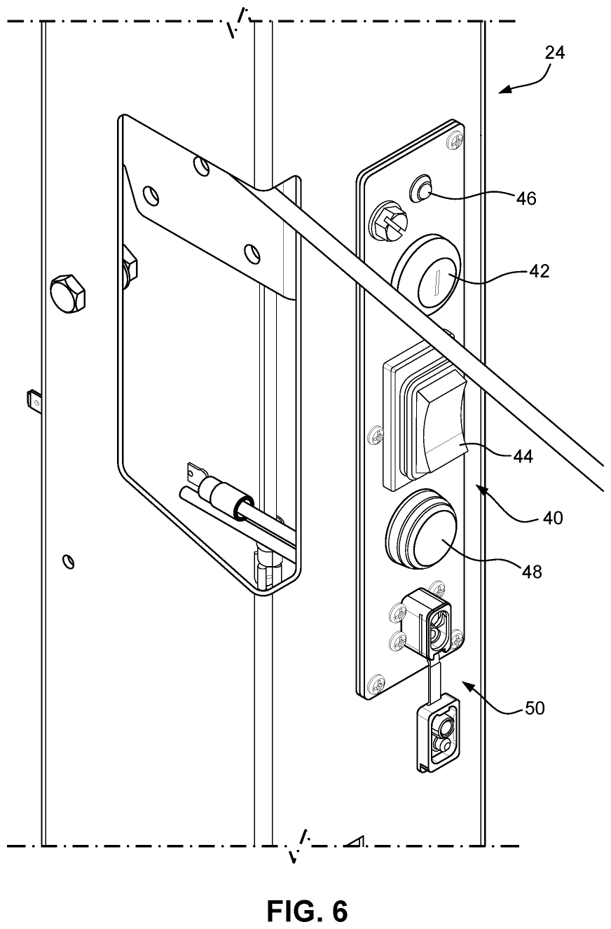

A streamlined and fully-integrated control panel 40 is mounted adjacent the door 12. In some embodiments, the control panel 40 is mounted at the lower end of one side of the side door jamb 24 and includes all operational features for the system. In some embodiments, with reference to FIG. 6, the control panel 40 includes a key switch 42 to activate the door operating mechanism and a rocker switch 44 to extend and retract the cylinder rod 30. The control panel 40 may also be provided with a warning indicator light 46 and a mute button 48 for silencing a warning buzzer. The control panel may include an SAE plug 50 for battery backup connection. The control panel 40 is electrically connected with the motors 26 via a wire harness of the wire harness system 38.

To power on, the user inserts a key into the key switch 42 and turns it 90 degrees. The door 12 is extended and retracted via the rocker switch 44, which is preferably a waterproof rocker switch. The mute button 48 can be used to silence a warning buzzer that goes off during deployment of the door for noise sensitive areas or time of day. The SAE plug 50 provides a battery backup connection in the event of loss of power in the vehicle.

With continued reference to FIG. 1, the cable 32 is threaded through the pulley system 34 and attaches to a location on the ramp door 12 that is proximal to the door hinge. To extend the door to the patio deck position, the motor 26 is activated to extend the cylinder rod 30, which displaces the cable 32 downward within the jamb 24 to elongate the cable 32 out of the pulley system 34 and through an opening in the lower end of the side door jamb 24. One or two fixed cables or tethers 52 are attached between the frame 22 and the door 12 to support the door 12 in the deck position. Once the tethers 52 are released, the cylinder 28 can be further actuated by the motor 26 to extend the door 12 to the ramp position. The motor 26 is reversed, and the cylinder rod 30 is retracted to also retract the cable 32 back into the jamb 24 and return the door 12 into the stowed or closed position.

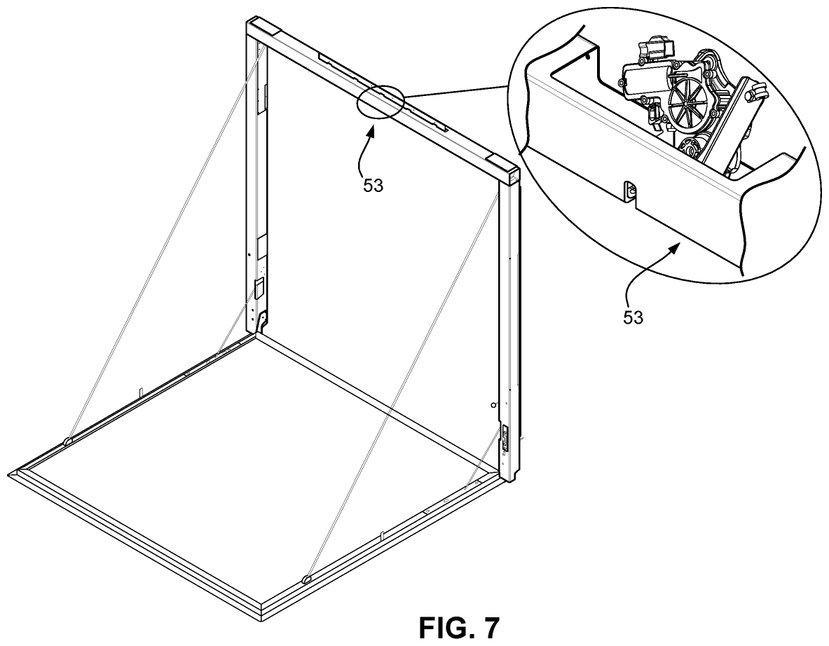

In some embodiments, the door 12 may be locked in the closed position by an electric cinch latch. By using this latch, the user guides a door closed with one hand, and the latch grabs the door and closes it the rest of the way. Alternatively, a manual compression latch may be used. The total number of latches used generally determines their position within the header. The cinch latch may be placed at the center of the header of the jamb, but is not limited to placement at this location. A manual latch may be located in at least one side of the jamb at a position that is accessible by the user. Any suitable latching mechanism may be used with the door. An exemplary electric cinch latch 53 is shown in FIG. 7.

A gas shock 54 acts as a door opening assist so that the door does not stick prior to actuation. Once the door is unlocked, the gas shock 54 expands to open the door about 15°.

A limit switch 56 may be installed in the frame 22 to act as an anti-tampering device. Once the door 12 is displaced to the closed position, the limit switch 56 cuts power to the system so that the door is not operable if the key is accidentally left in the control panel 40.

The door may be provided with decals on both sides to indicate where the pinch points are when the door opens/closes.

The powered ramp door assembly of the described embodiments is fully contained within the door frame and can be easily and quickly connected to vehicle power after installation. The controls are consolidated and self-contained within the side door jamb. The jamb is pre-wired with wire harnesses for powering the door prior to installation, and the OEM can readily connect power to the system via a plug-n-play connector.

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims.

1. A door operating mechanism for displacing a door between a closed position and a deck position relative to a structure including a frame with a side door jamb and a head door jamb, the door operating mechanism comprising:
a motor;
an actuator connected to the motor and disposed within the side door jamb;
a cable connected at one end to the actuator and at an opposite end to the door via a pulley assembly;
a wire harness system electrically connecting the motor to a plug connector; and
a control panel mounted adjacent the door and coupled with the motor via the wire harness system.

2. A door operating mechanism according to claim 1, further comprising a compression spring interposed between the cylinder rod and the cable.

3. A door operating mechanism according to claim 1, further comprising a fixed tether connected between at least one of the side door jamb and the head door jamb and the door.

4. A door operating mechanism according to claim 1, further comprising one of an electric cinch latch and a manual compression latch for securing the door in the closed position.

5. A door operating mechanism according to claim 1, further comprising a gas shock secured to the side door jamb and positioned to engage the door in the closed position, the gas shock being biased to displace the door toward an open position.

6. A door operating mechanism according to claim 1, further comprising a limit switch positioned in or adjacent one of the side door jamb and the head door jamb that disconnects power to the motor when the door is displaced to the closed position.

7. A door operating mechanism according to claim 1, wherein the control panel comprises a key switch to activate the door operating mechanism and a rocker switch to extend and retract the cylinder rod, the key switch and the rocker switch being connected to the motor via the wire harness system.

8. A door operating mechanism according to claim 7, wherein the control panel further comprises a warning indicator light and a mute button for silencing a warning buzzer.

9. A door operating mechanism according to claim 7, wherein the control panel further comprises an SAE plug for battery backup connection.

10. A door operating mechanism according to claim 1, wherein the actuator is a cylinder including an extendable and retractable cylinder rod.

11. A door operating mechanism according to claim 1, wherein the wire harness system is positioned within the door jamb.

12. A door operating mechanism according to claim 1, wherein the control panel is mounted on the side door jamb.

13. A door operating mechanism for displacing a door between a closed position and a deck position relative to a structure including a frame with two side door jambs and a head door jamb, the door operating mechanism comprising:
first and second motors positioned within the frame;
first and second actuators respectively connected to each of the first and second motors and disposed within the side door jambs;
first and second cables each respectively connected at one end to the actuators and at an opposite end to the door via respective pulley assemblies;
a wire harness system electrically connecting the first and second motors to a plug connector; and
a control panel mounted adjacent the door and coupled with the first and second motors via the wire harness system.

14. A door operating mechanism according to claim 13, wherein the wire harness system comprises a plurality of wire harnesses respectively connecting the first and second motors to the plug connector, connecting the control panel to the first and second motors, and connecting the first and second motors to each other.

15. A door operating mechanism according to claim 13, further comprising a compression spring interposed between each of the cylinder rods and the first and second cables, respectively.

16. A door operating mechanism according to claim 13, further comprising a pair of fixed tethers connected between the frame and the door.

17. A door operating mechanism according to claim 13, further comprising one of an electric cinch latch and a manual compression latch for securing the door in the closed position.

18. A door operating mechanism according to claim 13, further comprising a gas shock secured to one of side door jambs and positioned to engage the door in the closed position, the gas shock being biased to displace the door toward the deck position.

19. A door operating mechanism according to claim 13, wherein the actuators are first and second cylinders each including an extendable and retractable cylinder rod.

20. A door operating mechanism according to claim 13, wherein the wire harness system is positioned within the frame.

21. A door operating mechanism according to claim 13, wherein the control panel is mounted on one of the side door jambs
